(19) United States
(12) Patent Application Publication
(10) Pub. No.: US 2010/0006651 A1
(43) Pub. Date: Jan. 14, 2010

(54) CARD READING DEVICE FOR TRANSACTION SYSTEM

(76) Inventor: Jason HSIEH, Taipei Hsien (TW)

Correspondence Address: Muncy, Geissler, Olds & Lowe, PLLC, P.O. BOX 1364, FAIRFAX, VA, 22038-1364, US

(21) Appl. No.: 12/500,021

(22) Filed: Jul. 9, 2009

(30) Foreign Application Priority Data
Jul. 10, 2008 (TW) 97212282

(51) Int. Cl. G06K 7/08

(52) U.S. Cl. 235/449

(57) ABSTRACT

A card reading device for a transaction system is configured with a first reading unit and a second reading unit respectively reading a contact card and a contactless card, converting read analog signals to digital signals with the same preset format, and then transmitting them to a transaction terminal to carry out a transaction, thereby not only allowing a user to select the use of the contact card or contactless card freely but also increasing purchasing convenience effectively.

### CROSS-REFERENCES TO RELATED APPLICATIONS

This non-provisional application claims priority under 35 U.S.C. §119(a) on Patent Application No(s). 97212282 filed in Taiwan, R.O.C. on Jul. 10, 2008, the entire contents of which are hereby incorporated by reference.

### FIELD OF THE INVENTION

The present invention relates to a card reading device for a transaction system, and more particularly to a card reading device of a transaction system combined with contactless data transmission.

### BACKGROUND

Accompanying the progress of technology and the change of business modes, the use of plastic money such as credit card as a method of payment is becoming more popular. A card holder does not have to carry cash with them, facilitating the convenience of consumer transactions. Plastic money therefore replaces cash transactions, and becomes the main stream business transaction method.

The current card payment mechanism is shown in FIG. 1. A reading unit A11 in a card reader A1 is used to read data in a card holder's credit card, and the analog data is converted to digital data through an analog/digital converting chip A12 in the card reader A1. Finally, the digital data is transmitted to a transaction terminal A2, and this transaction can then be confirmed after the data in the credit card is verified.

Purchasing is not limited to a local area due to the popularity of no-shop sales; people can make purchases even if they are in a vehicle. However a consumer must take out a credit card and insert it in a card reader in order to make such a transaction while in a vehicle, which is very inconvenient for a consumer. The transaction process is complex and tedious to the extent of decreasing consumer purchase interest.

### SUMMARY OF THE INVENTION

To improve a transaction system and a card reading device thereof, simplifying the transaction process thereof and increase effectively the convenience of the user's purchasing transaction, the present invention proposes a card reading device for a transaction system, including a first reader, adapted to read a contact card and output a first analog signal; a converting chip, adapted to convert the first analog signal to a first digital signal with a preset format; a second reader, adapted to read contactless card and output a second analog signal; a converter module, adapted to converting the second analog signal to a second digital signal; and an integrator module, receiving the first digital signal, transmitting it to a transaction terminal, and receiving the second digital signal, converting it to a signal conforming to the preset format and transmitting it to the transaction terminal.

The present invention also proposes a card reading device for a transaction system, including a first reader, adapted to read a contact card and output a first analog signal; a converting chip, adapted to covert the first analog signal to a first digital signal with a preset format and transmit the first digital signal to a transaction terminal; a second reader, adapted to read contactless card and output a second analog signal; a converter module, adapted to converting the second analog signal to a second digital signal; and an integrator module, receiving the second digital signal, converting it to a signal conforming to the preset format and transmitting it to the transaction terminal.

The present invention can read a contact card and a contactless card simultaneously, convert a read analog signal to a digital signal with the same preset format, and then transmit it to a transaction terminal to carry out a transaction so that a user may chose the use of a contact card or a contactless card freely and complete the whole transaction easily during a purchasing, thereby simplifying the transaction flow of a user's purchase and increasing purchasing convenience.

### BRIEF DESCRIPTION OF THE DRAWINGS

The present invention can be more fully understood by reference to the following description and accompanying drawings, in which:

FIG. 1 is a schematic view of a conventional credit card payment mechanism;

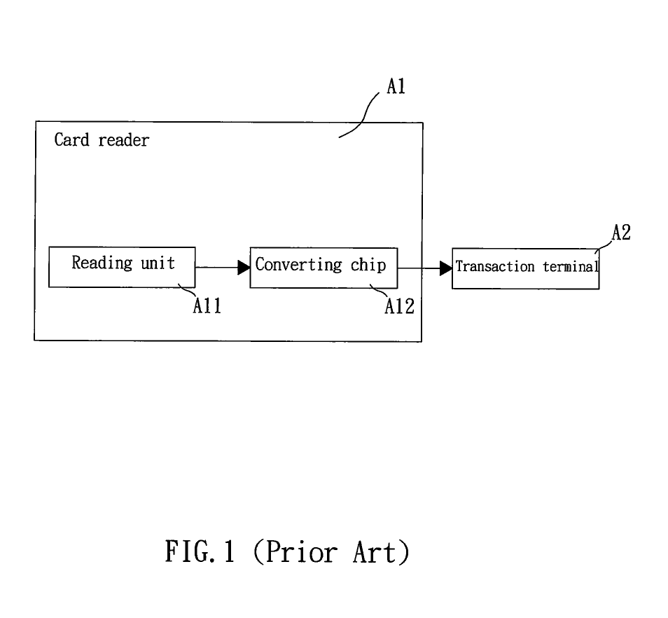

FIG. 2 is a block diagram, showing hardware of a first embodiment according to the present invention;

FIG. 3 is a block diagram, showing hardware of a second embodiment according to the present invention; and

FIG. 4 is a schematic view of the second embodiment according to the present invention.

### DETAILED DESCRIPTION OF THE PREFERRED EMBODIMENTS

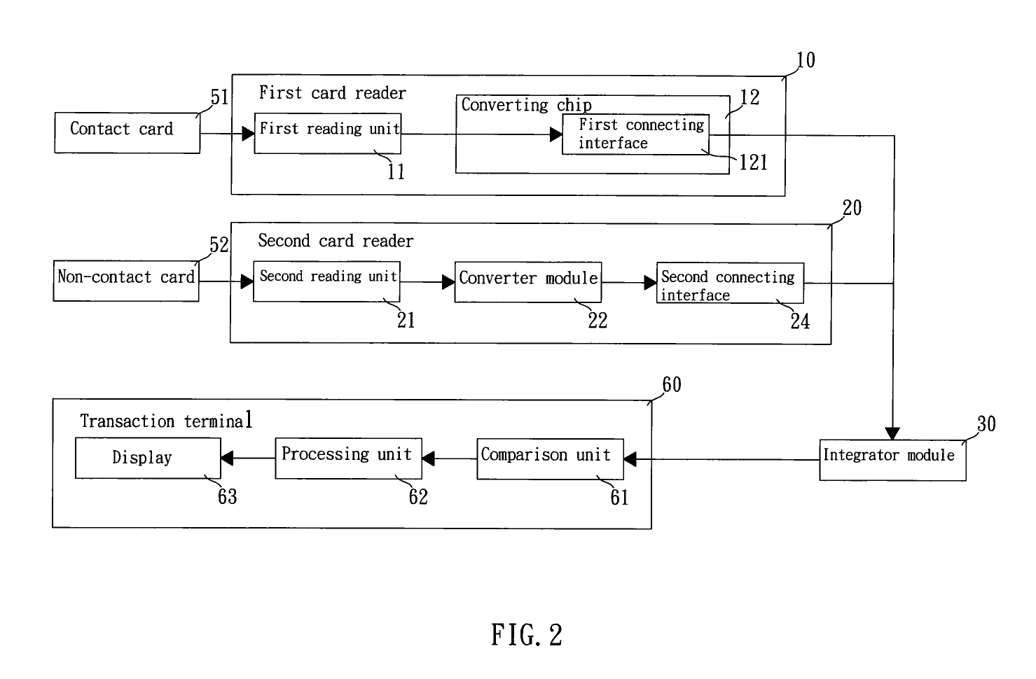

Please refer to FIG. 2. FIG. 2 shows a first embodiment according to the present invention:

A card reading device for a transaction system according to the present invention includes a first card reader 10, a second card reader 20, an integrator module 30, a transaction terminal 60.

The first reader 10 is configured with a first reading unit 11 and a converting chip 12; the first reading unit 11 is adapted to read a contact card 51, output a first analog signal, and convert the first analog signal to a first digital signal with a preset format through the converting chip 12. In addition, the converting chip 12 may be inbuilt with a first connecting interface 121, but it is not limited to this according to the present invention.

The second card reader 20 is configured with a second reading unit 21, a converter module 22 and a second connecting interface 24; the second reading unit 21 is adapted to read a contactless card 52, output a second analog signal, and convert the second analog signal to a second digital signal through the converter module 22. Furthermore, the second connecter interface 24 may be selected from a group constituted by RS 232 interface, USBOTG interface, IEEE 1394 standard interface and PCMCIA standard interface, where the second connecter interface 24 may preferably be a RS 232 interface, but it is not limited to this according to the present invention.

The integrator module 30 is respectively connected to the first connecting interface 121 and the second connecting interface 24; it is adapted to receive the first digital signal and the second digital signal, and can convert the second digital signal to a signal conforming to the preset format after receiving the second digital signal, enabling both the first digital signal and the second digital signal to be formatted with the same preset format.

The aforementioned contact card 51 has a magnetic strip or contact chip, and it may be a cash card, bank card or credit card. The contactless chip 52 may preferably be a radio frequency identification (RFID) chip and may also be a cash card, bank card or credit card, where the structures and the types of the contact card 51 and the contactless card are only given as examples, but they are not limited to these according to the present invention; the first reading unit 11 and the second reading unit 21 may also be proper cards capable of reading depending on practical needs.

The transaction terminal 60 can receive the first digital signal or the second digital signal transmitted from the integrator module 30 and carry out a transaction depending on the first digital signal or the second digital signal received thereby, where the transaction terminal 60 may be a point of sale (POS) terminal, home computer system, bank automated teller machine (ATM) terminal, digital television, network facility or personal point of sale (POS) terminal, but it is not limited to these according to the present invention.

Furthermore, the transaction terminal 60 is disposed with a comparison unit 61, a processing unit 62 and a display 63, where the comparison unit 61 may compare the first digital signal or the second digital signal, and the process unit 92 processes a transaction depending on the first digital signal or the second digital signal after the comparison. In addition, the structure of the transaction terminal 60 is only given as an example, and it is not limited to this according to the present invention and may be changed or adjusted depending on practical needs, for example, it may be added with a printer, bar-code reader and etc.

The following description will take the present invention being applied on a high speed rail train as an example for the purpose of explanation, but it is not limited to this; the present invention can be applied to a place such as a room with a security entrance guard system.

A user may check the type and the price of a merchandise through a shopping magazine or a television. They can then take out plastic money such as a bank card or a credit card to pay the price of a selected article if they want to buy it. The first reading unit 11 may be used to read the contact card 51 if the plastic money is the contact card 51; the first reading unit 11 reads the data of the card such as the card number, the card holder of the contact card 51, outputs the first analog signal, transmits the signal to the integrator module 30 after the first analog signal is converted to a first digital signal through the converting chip 12 and then transmits it to the transaction terminal 60 to carry out the transaction through the integrator module 30. The second reading unit 21 may be used to read the contactless chip 52 if the plastic money is the contactless chip 52; the second reading unit 21 reads the data of the card such as the card number and the card holder of the contactless chip 52, outputs the second analog signal, converts the second analog signal to the second digital signal through the converter module 22, transmits the second digital signal to the integrator module 30. Thereafter, the integrator module 30 converts the second digital signal to a signal conforming to a preset format and then transmits it to the transaction terminal 60 to carry out the transaction.

After the transaction terminal 60 receives the first digital signal or the second digital signal, the comparison unit 61 is first used to compare the first digital signal or the second digital signal, the processing unit 62 carries out the transaction if the signal is correct, and the display 63 is used to display the result of the transaction.

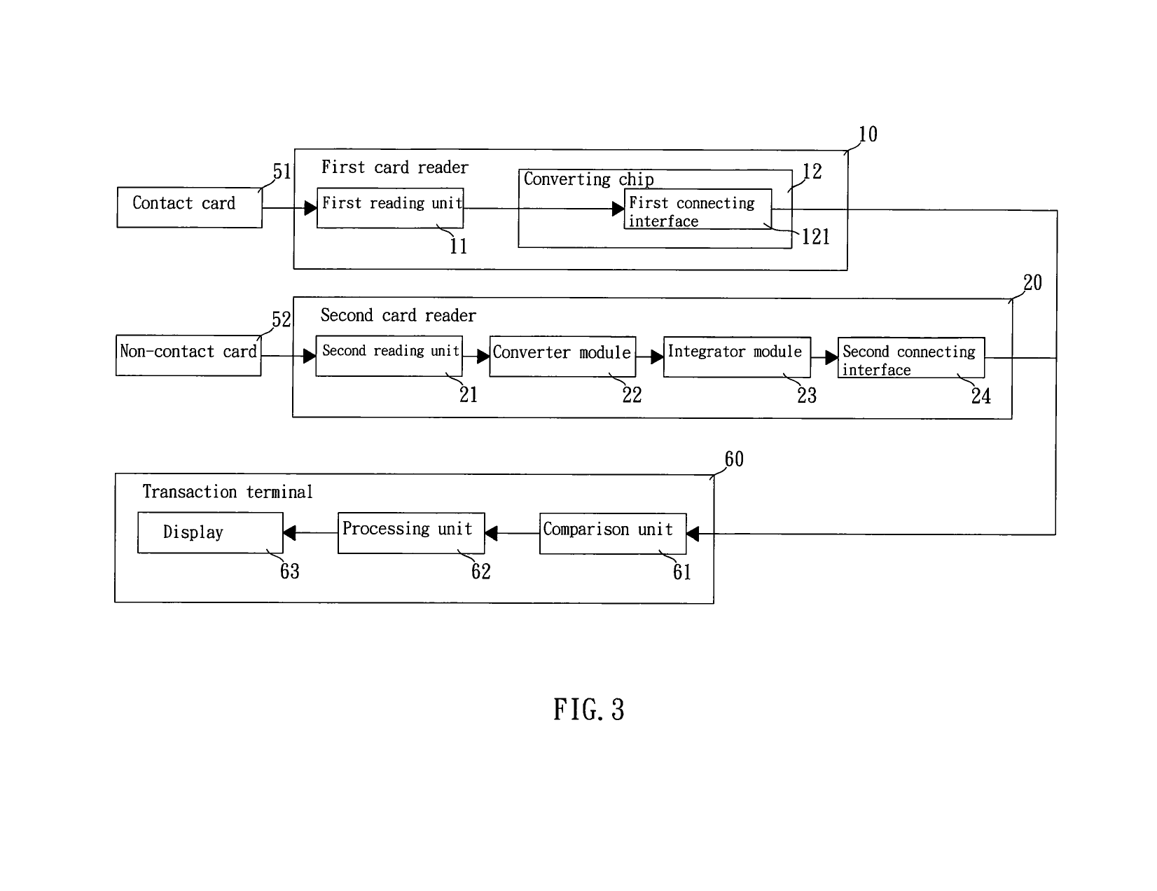

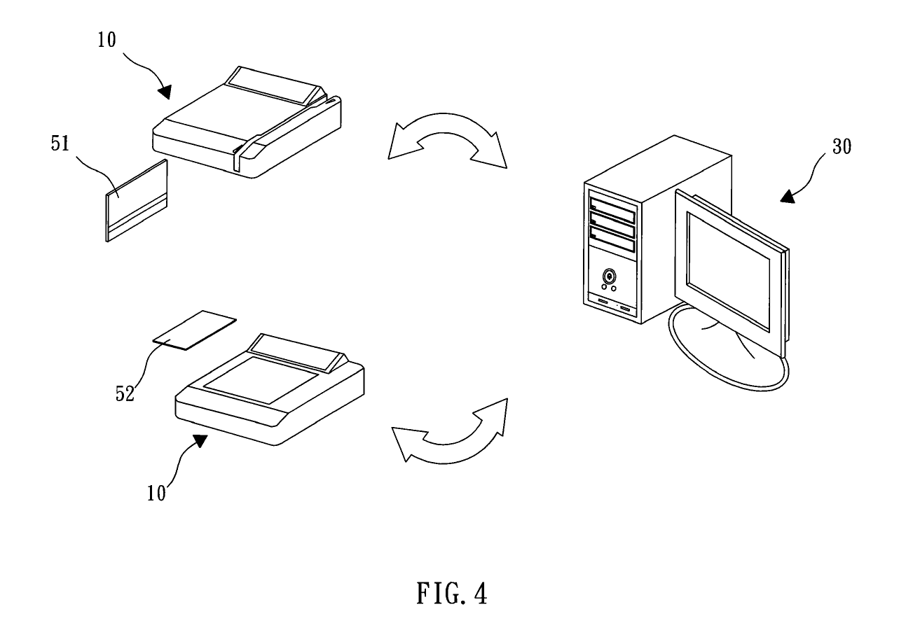

Please refer to FIGS. 3 and 4. The figures illustrate a second embodiment according to the present invention.

In the present embodiment, the second card reader may further be disposed with an integrator module, a second analog signal is converted to a second digital signal after the second reading unit 21 reads the contactless card 52 and outputs the second analog signal, and the integrator module 23 is then used to convert the second digital signal to a signal conforming to the preset format after it receives the second digital signal, allowing both the first digital signal and the second digital signal to be the same preset format, and the second digital signal can then be transmitted to the transaction terminal 60 through the second connecting interface 24. In addition, the first analog signal is converted to a signal with the preset format through the converting chip 12 after the first reading unit 11 reads the contact card 51 and outputs the first analog signal, and the first digital signal may then be transmitted to the transaction terminal 60 through the first connecting interface 121,

The present invention uses a first reading unit to read a contact card and a second reading unit to read a contactless card, converts a first analog signal or second analog signal to a first digital signal or second digital signal with the same preset format, and then transmits it to a transaction terminal to carry out a transaction. In this way, a user can complete the whole transaction easily no matter what kind of plastic money they use during purchasing (contact card or contactless). In addition, the user only needs to put the contactless card within a certain range of the second reading unit, and does not need to pass through complex and tedious card paying procedures if they use the contactless card to carry out a transaction. Thus the transaction flow of a user's purchase can be simplified, and furthermore the purchasing convenience can be increased effectively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A card reading device for a transaction system, comprising:
a first reading unit, adapted to read a contact card and output a first analog signal;
a converting chip, adapted to convert said first analog signal to a first digital signal with a preset format;
a second reading unit, adapted to read a contactless card and output a second analog signal;
a converter module, adapted to convert said second analog signal to a second digital signal, and
an integrator, transmitting said first digital signal to a transaction terminal after receiving said first digital signal, converting said second digital signal to a signal conforming to said preset format after receiving said second digital signal, and transmitting said second digital signal with said preset format to said transaction terminal.

2. The card reading device for a transaction system according to claim 1, wherein said contact card comprises a magnetic strip.

3. The card reading device for a transaction system according to claim 1, wherein said converting chip comprises a first connecting interface connected with said integrator module.

4. The card reading device for a transaction system according to claim 1, wherein said converter module is connected with said integrator through a second connecting interface.

5. The card reading device for a transaction system according to claim 1, wherein said contactless card comprises a contactless chip.

6. The card reading device for a transaction terminal according to claim 1, further comprising a transaction system, carrying out a transaction depending on one of said first digital signal and said second digital signal.

7. The card reading device for a transaction system according to claim 6, wherein said transaction terminal comprises a comparison unit, adapted to compare one of said first digital signal and said second digital signal.

8. The card reading device for a transaction system according to claim 6, wherein said transaction terminal comprises a processing unit adapted to process said transaction.

9. The card reading device for a transaction system according to claim 6, wherein said transaction terminal comprises a display adapted to display a result of said transaction.

10. A card reading device for a transaction system, comprising:
a first reading unit, adapted to read a contact card and output a first analog signal;
a converting chip, adapted to convert said first analog signal to a first digital signal with a preset format, and transmit said first digital signal to a transaction system;
a second reading unit, adapted to read a contactless card and output a second analog signal;
a converter module, adapted to convert said second analog signal to a second digital signal, and
an integrator, converting said second digital signal to a signal conforming to said preset format after receiving said second digital signal, and transmitting said second digital signal with said preset format to said transaction terminal.

11. The card reading device for a transaction system according to claim 10, wherein said contact card comprises a magnetic strip.

12. The card reading device for a transaction system according to claim 10, wherein said contactless card is selected from a group constituted by a cash card, bank card and credit card.

13. The card reading device for a transaction system according to claim 10, wherein said converting chip comprises a first connecting interface connected with said integrator module.

14. The card reading device for a transaction system according to claim 10, wherein said converter module is connected with said integrator through a second connecting interface.

15. The card reading device for a transaction system according to claim 10, wherein said contactless card comprises a contactless chip.

16. The card reading device for a transaction system according to claim 10, further comprising a transaction terminal, carrying out a transaction depending on one of said first digital signal and said second digital signal.

17. The card reading device for a transaction system according to claim 16, wherein said transaction terminal comprises a comparison unit, adapted to compare one of said first digital signal and said second digital signal.

18. The card reading device for a transaction system according to claim 16, wherein said transaction terminal comprises a processing unit adapted to process said transaction.

19. The card reading device for a transaction system according to claim 16, wherein said transaction terminal comprises a display adapted to display a result of said transaction.
